(19) United States
(12) Patent Application Publication
(10) Pub. No.: US 2026/0269470 A1
(43) Pub. Date: Sep. 10, 2026

(54) DUAL-POLARIZED RADIATING UNIT AND ULTRA-WIDEBAND ANTENNA

(71) Applicant: Telefonaktiebolaget LM Ericsson (publ), Stockholm (SE)

(72) Inventors: Jiatong Liu, Chaoyang District, Beijing (CN); Zhongliang He, Chaoyang District, Beijing (CN); Chuan Chen, Chaoyang District, Beijing (CN); Xu Liu, Chaoyang District, Beijing (CN)

(21) Appl. No.: 19/167,727

(22) PCT Filed: Mar. 25, 2024
(86) PCT No.: PCT/CN2024/083677

§ 371 Date: Sep. 22, 2025

(30) Foreign Application Priority Data
Mar. 29, 2023 (CN) 202320660109.2

(51) Int. Cl. H01Q 5/25; H01Q 9/16; H01Q 15/24

(52) U.S. Cl. CPC H01Q 5/25; H01Q 9/16; H01Q 15/24

(57) ABSTRACT

The dual-polarized radiating unit includes: a support element; a first radiating element including a first coupling sheet capable of being inserted into the support element along an insertion direction; a second radiating element including a second coupling sheet capable of being inserted into the support element along an insertion direction; a third radiating element, forming a first dipole with the first radiating element, including a third coupling sheet capable of being inserted into the support element along an insertion direction, the third coupling sheet adjacent the first coupling sheet and extending in parallel with the first coupling sheet; and a fourth radiating element, forming a second dipole with the second radiating element, comprising a fourth coupling sheet capable of being inserted into the support element in the insertion direction, the fourth coupling sheet adjacent the second coupling sheet and extending in parallel with the second coupling sheet.

### CROSS-REFERENCE

This application claims the benefit of Chinese Patent Application No. 202320660109.2 filed on Mar. 29, 2023, entitled “DUAL-POLARIZED RADIATING UNIT AND ULTRA-WIDEBAND ANTENNA”, which is hereby incorporated by reference in its entirety.

### FIELD

Embodiments of the present disclosure generally relate to the field of communication antenna technology and, more specifically, to a dual-polarized radiating unit and an ultra-wideband antenna including the dual-polarized radiating unit.

### BACKGROUND

Ultra-wideband (UWB) technology is a wireless carrier communication technology that utilizes narrow pulses of non-sinusoidal waves at the nanosecond level to transmit data, and therefore occupies a wide range of spectrum.

Ultra-wideband antenna elements are becoming increasingly popular in 5G advanced antenna systems (5G AAS) due to supporting modularity of multiple radios. Currently, ultra-wideband antennas have two conventional solutions, namely die-cast dipole antennas and printed circuit board (PCB) dipole antennas. The die-cast dipole antennas are widely used in 4G macro station antennas using a metal die-casting process. However, the weight of die-cast dipole antennas is too heavy to be applied in the 5G AAS. The PCB dipole antennas are another UWB solution for 4G macro station antennas. However, the PCB dipole antennas have too many solder joints, which on the one hand will lead to a higher risk of intermodulation distortion (PIM), especially for frequency division duplex (FDD) products, and on the other hand will require a complex soldering process that increases production costs.

### SUMMARY

An object of the present disclosure is to provide a dual-polarized radiating unit and an ultra-wideband antenna to at least partially solve the above problem.

In a first aspect of the present disclosure, there is provided a dual-polarized radiating unit comprising: a support element; a first radiating element comprising a first coupling sheet capable of being inserted into the support element along an insertion direction; a second radiating element comprising a second coupling sheet capable of being inserted into the support element along the insertion direction; a third radiating element forming a first dipole with the first radiating element, the third radiating element comprising a third coupling sheet capable of being inserted into the support element along the insertion direction, the third coupling sheet being adjacent to the first coupling sheet and extending in parallel with the first coupling sheet; and a fourth radiating element forming a second dipole with the second radiating element, the fourth radiating element comprising a fourth coupling sheet capable of being inserted into the support element along the insertion direction, the fourth coupling sheet being adjacent to the second coupling sheet and extending in parallel with the second coupling sheet.

In some embodiments, the support element comprises first and second support plates extending along the insertion direction respectively, and each of the first and second support plates comprises first and second sides opposite to each other; the first coupling sheet is capable of being inserted into the support element along the first side of the first support plate; the second coupling sheet is capable of being inserted into the support element along the first side of the second support plate; the third coupling sheet is capable of being inserted into the support element along the second side of the first support plate; and the fourth coupling sheet is capable of being inserted into the support element along the second side of the second support plate.

In some embodiments, the first and second sides of each of the first and second support plates are provided with a slot or a pair of snaps, respectively, for a corresponding coupling sheet to be inserted therein.

In some embodiments, each of the first, second, third, and fourth radiating elements further comprises a main radiating arm extending along a direction perpendicular to the insertion direction, each main radiating arm comprises a circumferential arm encircling a predefined shape and a connecting arm extending inside the circumferential arm, the first, second, third, and fourth coupling sheets are connected to a peripheral corner portion of the corresponding circumferential arm respectively, and each connecting arm is capable of being connected to the support element.

In some embodiments, each connecting arm comprises a first mounting hole, and the support element comprises a first snap-fitting member and a first limiting member arranged in a group, each first snap-fitting member is capable of being snap-fitted to a side of the corresponding connecting arm via the corresponding first mounting hole, and each first limiting member is capable of abutting against the other side of the corresponding connecting arm in a case that the corresponding first snap-fitting member is snap-fitted to the side of the corresponding connecting arm.

In some embodiments, each connecting arm further comprises a guiding hole, and the support element further comprises a guiding member arranged in a group with the first snap-fitting member and the first limiting member, each guiding member is capable of being inserted into the corresponding guiding hole.

In some embodiments, each of the first, second, third, and fourth radiating elements further comprises at least one of: a first bending arm bent along the insertion direction from a side of the circumferential arm; and a second bending arm bent along the insertion direction from another corner portion of the circumferential arm opposite to the peripheral corner portion.

In some embodiments, the first radiating element further comprises a first intersecting part, wherein the first coupling sheet is connected the peripheral corner portion of the corresponding circumferential arm via the first intersecting part, the second radiating element further comprising a second intersecting part, wherein the second coupling sheet is connected to the peripheral corner portion of the corresponding circumferential arm via the second intersecting part, and the first intersecting part and the second intersecting part intersect with each other and are spaced apart from each other along the insertion direction.

In some embodiments, the support element further comprises a second snap-fitting member and a second limiting member arranged in a group, each second snap-fitting member is capable of being snap-fitted to a side of a feeding circuit board via a second mounting hole on the feeding circuit board, and each second limiting member is capable of abutting against the other side of the feeding circuit board in a case that the corresponding second snap-fitting member is snap-fitted to the side of the feeding circuit board, and ends of the first, second, third, and fourth coupling sheets are capable of being soldered to the feeding circuit board.

In some embodiments, each of the first, second, third, and fourth radiating elements is a sheet-metal stamping member formed integrally.

In some embodiments, the support element is an injection-molded plastic member.

In a second aspect of the present disclosure, there is provided an ultra-wideband antenna comprising: a metal reflection plate; and at least two dual-polarized radiating units according to the first aspect of the present disclosure, arranged on the metal reflection plate.

According to embodiments of the present disclosure, the overall weight of the dual-polarized radiating unit can be significantly reduced, and assembling of the dual-polarized radiating unit can be implemented in a simple manner, reducing the number of solder joints and thereby reducing the risk of intermodulation distortion.

It should be understood that the content described in the summary is not intended to limit critical or important features of the embodiments of the present disclosure, nor is it used to limit the scope of the present disclosure. Other features of the present disclosure will become easier to be understood through the following description.

### BRIEF DESCRIPTION OF THE DRAWINGS

The foregoing and other features, advantages, and aspects of embodiments of the present disclosure will become more apparent in conjunction with the accompanying drawings and with reference to the following detailed description. In the accompanying drawings, the same or similar reference signs denote the same or similar elements, wherein:

FIG. 1 illustrates a perspective view of a dual-polarized radiating unit according to an embodiment of the present disclosure;

FIG. 2 illustrates an exploded schematic view of the dual-polarized radiating unit shown in FIG. 1;

FIGS. 3 and 4 illustrate perspective views of the dual-polarized radiating unit shown in FIG. 1 when viewed along a perspective different from FIG. 1;

FIG. 5 illustrates a perspective view of a support element according to an embodiment of the present disclosure;

FIG. 6 illustrates a perspective view of a first radiating element according to an embodiment of the present disclosure;

FIG. 7 illustrates a perspective view of a second radiating element according to an embodiment of the present disclosure;

FIG. 8 illustrates a perspective view of a third radiating element according to an embodiment of the present disclosure;

FIG. 9 illustrates a perspective view of a fourth radiating element according to an embodiment of the present disclosure;

FIGS. 10 and 11 illustrate schematic assembling views of the dual-polarized radiating unit on a feeding circuit board according to an embodiment of the present disclosure;

FIG. 12 illustrates a schematic structural view of an ultra-wideband antenna according to an embodiment of the present disclosure.

### DETAILED DESCRIPTION

Preferred embodiments of the present disclosure will be described in larger detail below with reference to the accompanying drawings. Although preferred embodiments of the present disclosure are shown in the accompanying drawings, it should be understood, however, that the present disclosure may be realized in various forms without being limited by the embodiments set forth herein. Rather, these embodiments are provided to make the present disclosure more thorough and complete and to enable the scope of the present disclosure to be communicated in its entirety to those skilled in the art.

As used herein, the term “comprising” and variations thereof denotes open-ended inclusion, i.e., “comprising but not limited to”. Unless specifically stated, the term “or” denotes “and/or”. The term “based on” means “at least partially based on”. The terms “an example embodiment” and “an embodiment” denote “at least one example embodiment”. The term “another embodiment” denotes “at least one additional embodiment”. The terms “first”, “second”, etc. may refer to different or identical objects.

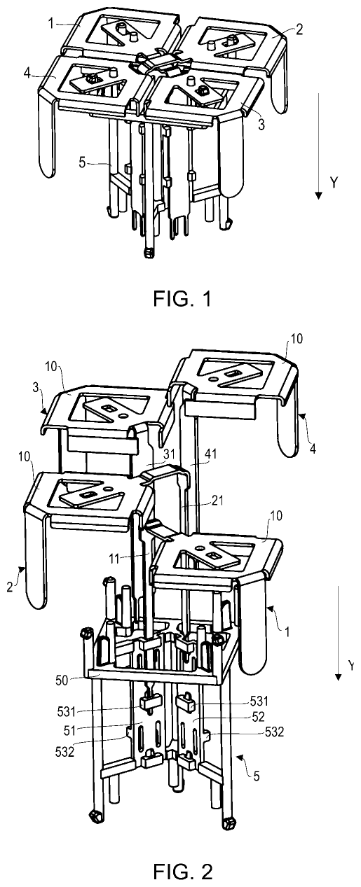

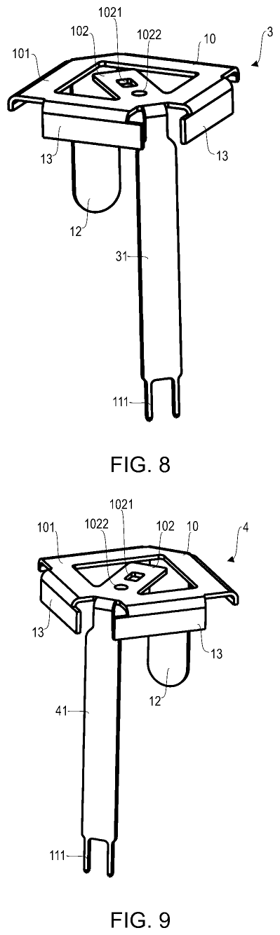

As described in the above, the weight of die-cast dipole antennas is too heavy to be applied in the 5G AAS; the PCB dipole antennas have too many solder joints, which on the one hand leads to a higher risk of PIM, and on the other hand will require a complex soldering process that increases production costs. Embodiments of the present disclosure provide a dual-polarized radiating unit and an ultra-wideband antenna that can significantly reduce the overall weight of the dual-polarized radiating unit and enable assembling of the dual-polarized radiating unit in a simple manner, reducing the number of solder joints and thereby reducing the risk of intermodulation distortion. Example embodiments of the present disclosure will be described below in conjunction with FIGS. 1-12.

FIG. 1 illustrates a perspective view of a dual-polarized radiating unit according to an embodiment of the present disclosure, and FIG. 2 illustrates an exploded schematic view of the dual-polarized radiating unit shown in FIG. 1. As shown in FIGS. 1 and 2, the dual-polarized radiating unit described herein generally includes a support element 5 and first, second, third, and fourth radiating elements 1, 2, 3, 4 capable of being inserted into the support element 5 along an insertion direction Y.

The first radiating element 1 includes a first coupling sheet 11 capable of being inserted into the support element 5 along the insertion direction Y, and the third radiating element 3 includes a third coupling sheet 31 capable of being inserted into the support element 5 along the insertion direction Y. In a case that the third coupling sheet 31 and the first coupling sheet 11 are inserted into the support element 5, the third coupling sheet 31 is adjacent to the first coupling sheet 11 and extends in parallel with the first coupling sheet 11. The third coupling sheet 31 and the first coupling sheet 11 are electromagnetically coupled to each other such that the third radiating element 3 forms a first dipole with the first radiating element 1 for signal transmission and reception of a radio channel.

Similarly, the second radiating element 2 includes a second coupling sheet 21 capable of being inserted into the support element 5 along the insertion direction Y, and the fourth radiating element 4 includes a fourth coupling sheet 41 capable of being inserted into the support element 5 along the insertion direction Y. In a case that the fourth coupling sheet 41 and the second coupling sheet 21 are inserted into the support element 5, the fourth coupling sheet 41 is adjacent to the second coupling sheet 21 and extends in parallel with the second coupling sheet 21. The fourth coupling sheet 41 and the second coupling sheet 21 are electromagnetically coupled to each other such that the fourth radiating element 4 forms a second dipole with the second radiating element 2 for signal transmission and reception of another radio channel.

In some embodiments, the width of the first coupling sheet 11 is less than the width of the third coupling sheet 31, as shown in FIG. 2. However, this is used as an example only and is not intended to limit the scope of the present disclosure. In embodiments of the present disclosure, the width of the first coupling sheet 11 may also be larger than or equal to the width of the third coupling sheet 31, which may be set according to an impedance matching relationship between the first radiating element 1 and the third radiating element 3.

Similarly, the width of the second coupling sheet 21 may be less than, equal to or larger than the width of the fourth coupling sheet 41, which may be set according to an impedance matching relationship between the second radiating element 2 and the fourth radiating element 4.

In the embodiments shown in FIGS. 1 and 2, the insertion direction Y is substantially along the vertical direction, which is merely an example. It should be understood that when the dual-polarized radiating unit is in other orientations, the insertion direction Y will accordingly follow other directions.

According to embodiments of the present disclosure, the overall weight of the dual-polarized radiating unit can be significantly reduced, and assembling of the dual-polarized radiating unit can be implemented in a simple manner, reducing the number of solder joints and thereby reducing the risk of intermodulation distortion.

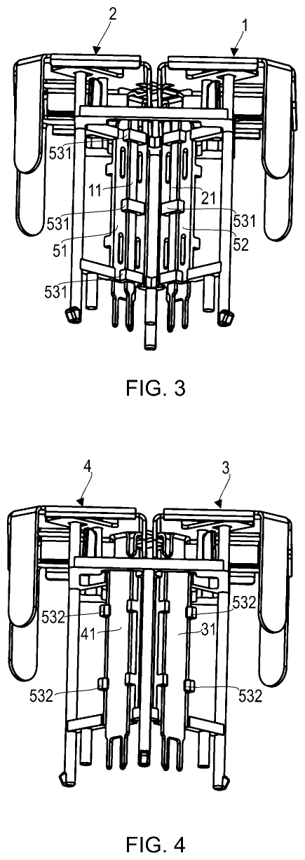

In an embodiment, as shown in FIG. 2, the support element 5 includes a first support plate 51 for separating the third coupling sheet 31 from the first coupling sheet 11 and a second support plate 52 for separating the fourth coupling sheet 41 from the second coupling sheet 21. The first support plate 51 and the second support plate 52 extend along the insertion direction Y, respectively, and each of them includes first and second sides opposite to each other. The first coupling sheet 11 is capable of being inserted into the support element 5 along the first side of the first support plate 51. The second coupling sheet 21 is capable of being inserted into the support element 5 along the first side of the second support plate 52. The third coupling sheet 31 is capable of being inserted into the support element 5 along the second side of the first support plate 51. The fourth coupling sheet 41 is capable of being inserted into the support element 5 along the second side of the second support plate 52. In a case that the third coupling sheet 31 and the first coupling sheet 11 are inserted into the support element 5, the third coupling sheet 31 and the first coupling sheet 11 are separated by the first support plate 51. The first support plate 51 serves as an insulating medium between the third coupling sheet 31 and the first coupling sheet 11 to ensure a coupling distance between the third coupling sheet 31 and the first coupling sheet 11. In a case that the fourth coupling sheet 41 and the second coupling sheet 21 are inserted into the support element 5, the fourth coupling sheet 41 and the second coupling sheet 21 are separated by the second support plate 52. The second support plate 52 serves as an insulating medium between the fourth coupling sheet 41 and the second coupling sheet 21 to ensure a coupling distance between the fourth coupling sheet 41 and the second coupling sheet 21. FIGS. 3-5 more clearly illustrate example structures of the first support plate 51 and the second support plate 52. In conjunction with FIGS. 2-5, the first side of the first support plate 51 is provided with a slot 531 for inserting and snap-fitting the first coupling sheet 11. The second side of the first support plate 51 is provided with a pair of snaps 532 for inserting and snap-fitting the third coupling sheet 31. The first side of the second support plate 52 is provided with a slot 531 for inserting and snap-fitting the second coupling sheet 21. The second side of the second support plate 52 is provided with a pair of snaps 532 for inserting and snap-fitting the fourth coupling sheet 41.

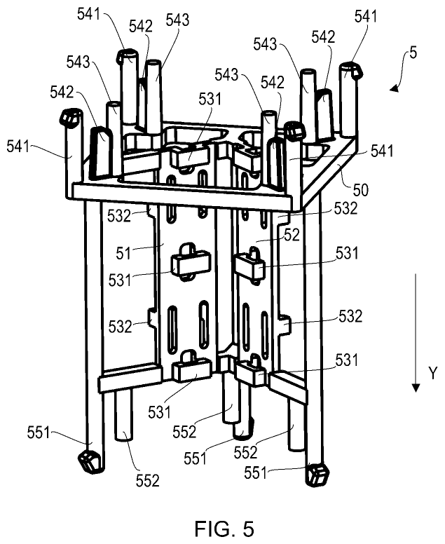

In some embodiments, as shown in FIGS. 3 and 5, a plurality of slots 531 are arranged on the first side of the first support plate 51 and spaced apart from each other, and the individual slots 531 are substantially aligned along the insertion direction Y. During insertion of the first coupling sheet 11 into the support element 5, the first coupling sheet 11 may pass through the individual slots 531 in turn along the insertion direction Y. Utilizing the plurality of slots 531, it is possible to securely snap-fitting the first coupling sheet 11 to the first side of the first support plate 51.

Similarly, as shown in FIGS. 3 and 5, a plurality of slots 531 may be arranged on the first side of the second support plate 52 and spaced apart from each other, and the individual slots 531 are substantially aligned along the insertion direction Y. During insertion of the second coupling sheet 21 into the support element 5, the second coupling sheet 21 may pass through the individual slots 531 in turn along the insertion direction Y. In this way, the second coupling sheet 21 may be securely snap-fitted to the first side of the second support plate 52.

In some embodiments, as shown in FIGS. 4 and 5, a plurality of pairs of snaps 532 are arranged on the second side of the first support plate 51 and spaced apart from each other, and each pair of snaps 532 are substantially aligned along the insertion direction Y. During insertion of the third coupling sheet 31 into the support element 5, the third coupling sheet 31 may be inserted into each pair of snaps 532 in turn along the insertion direction Y. Utilizing the plurality of pairs of snaps 532, the third coupling sheet 31 may be securely snap-fitted to the second side of the first support plate 51.

Similarly, as shown in FIGS. 4 and 5, a plurality of pairs of snaps 532 may be arranged on the second side of the second support plate 52 and spaced apart from each other, and each pair of snaps 532 are substantially aligned along the insertion direction Y. During insertion of the fourth coupling sheet 41 into the support element 5, the fourth coupling sheet 41 may be inserted into each pair of snaps 532 in turn along the insertion direction Y. In this way, the fourth coupling sheet 41 may be securely snap-fitted to the second side of the second support plate 52.

In some embodiments, instead of the slots 531, one or more pairs of snaps 532 may be provided on the first side of the first support plate 51 and the second support plate 52, respectively, for inserting and snap-fitting the first coupling sheet 11 and the second coupling sheet 21. Similarly, instead of the pair of snaps 532, one or more slots 531 may be provided on the second side of the first support plate 51 and the second support plate 52, respectively, for inserting and snap-fitting the third coupling sheet 31 and the fourth coupling sheet 41.

In some embodiments, instead of the slots 531 and the pair of snaps 532, other types of snap-fitting members may be provided on the first and second sides of each of the first support plate 51 and the second support plate 52, respectively, for the corresponding coupling sheet to be inserted therein, and the embodiments of the present disclosure are not intended to be limited in this regard.

Returning to FIG. 2, in some embodiments, each of the first, second, third, and fourth radiating elements 1, 2, 3, 4 further includes a main radiating arm 10 that extends in a direction perpendicular to the insertion direction Y. The first, second, third, and fourth coupling sheets 11, 21, 31, 41 are each connected to a corner portion of the corresponding main radiating arm 10 and are perpendicular to the extension direction of the main radiating arm 10.

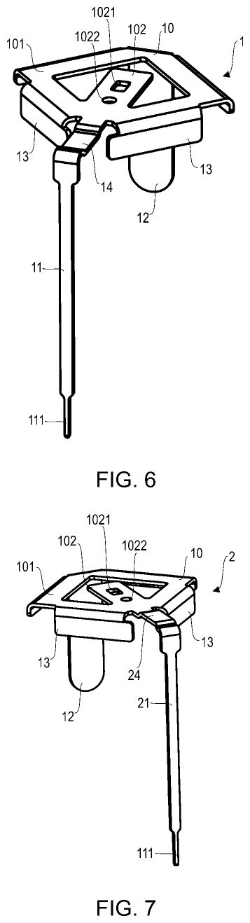

FIGS. 6-9 more clearly illustrate example structures of the first, second, third, and fourth radiating elements 1, 2, 3, 4. As shown in FIGS. 6-9, each main radiating arm 10 includes a circumferential arm 101 encircling a predetermined shape and a connecting arm 102 extending inside the circumferential arm 101. The first, second, third, and fourth coupling sheets 11, 21, 31, 41 are connected to the peripheral corner portion of the corresponding circumferential arm 101, respectively. Each connecting arm 102 is capable of being connected to the support element 5, which will be described below in conjunction with FIGS. 5-9. By inserting the first, second, third, and fourth coupling sheets 11, 21, 31, 41 into the support element 5 and connecting the individual connecting arms 102 to the support element 5, the first, second, third, and fourth radiating elements 1, 2, 3, 4 can be connected to the support element 5 stably and reliably.

In some embodiments, as shown in FIGS. 6-9, the predetermined shape may be a square, with the connecting arm 102 extending diagonally from one corner portion of the square. In some other embodiments, the predetermined shape may be other polygon, and the connecting arm 102 may extend from one corner portion of the polygon towards an opposite side of the polygon. In other embodiments, the predetermined shape may be other shapes, and embodiments of the present disclosure are not intended to be limited in this regard.

In some embodiments, as shown in FIGS. 5-9, in order to realize the connection between the individual connecting arms 102 and the support element 5, each connecting arm 102 includes a first mounting hole 1021, and the support element 5 includes a first snap-fitting member 541 and a first limiting member 542 arranged in a group. As shown in FIG. 5, the first snap-fitting member 541 and the first limiting member 542 in each group may be disposed on a base 50 and extend from the base 50 in a direction opposite to the insertion direction Y, respectively. The first support plate 51 and the second support plate 52 described above may extend from the base 50 along the insertion direction Y, i.e., be arranged on a side of the base 50 opposite to the first snap-fitting member 541 and the first limiting member 542.

In an embodiment, as shown in FIG. 5, the base 50 may be substantially square, and the first snap-fitting members 541 and the first limiting members 542 in each group may be disposed adjacent to a corner portion of the base 50. In other embodiments, the base 50 may have other shapes, and embodiments of the present disclosure are not intended to be limited in this regard.

In a case that the individual connecting arms 102 are connected to the support element 5, each first snap-fitting member 541 is capable of being snap-fitted to one side of the corresponding connecting arm 102 via the corresponding first mounting hole 1021, for example being snap-fitted to the top side of the individual connecting arms 102 shown in FIGS. 6-9. In a case that the individual first snap-fitting members 541 are snap-fitted to one side of the corresponding connecting arm 102, the corresponding first limiting member 542 is cable of abutting against the other side of the corresponding connecting arm 102, for example against the bottom side of the individual connecting arms 102 shown in FIGS. 6-9. In this way, the first, second, third, and fourth radiating elements 1, 2, 3, 4 may be connected to the support element 5 stably.

In some embodiments, when connecting the individual connecting arms 102 to the support element 5, in order to realize the guiding of the individual connecting arms 102, each connecting arm 102 further includes a guiding hole 1022, and the support element 5 further includes a guiding member 543 arranged in a group with the first snap-fitting member 541 and the first limiting member 542, as shown in FIGS. 5-9. Each guiding member 543 is substantially columnar, extends from the base 50 in a direction opposite to the insertion direction Y, and is capable of being inserted into the corresponding guiding hole 1022. With such an arrangement, the first, second, third, and fourth radiating elements 1, 2, 3, 4 can be easily and accurately connected to the support element 5 at appropriate locations.

In some embodiments, as shown in FIGS. 6-9, in order to achieve ultra-bandwidth and save radiating space, each radiating element of the first, second, third, and fourth radiating elements 1, 2, 3, 4 further includes a first bending arm 13 that is bent from the side of the circumferential arm 101 along the insertion direction Y. The impedance matching may be adjusted through increasing or decreasing the bending size of the first bending arm 13 along the insertion direction Y. In addition, the use of the first bending arm 13 can reduce the lateral dimension of the dual-polarized radiating unit along the direction perpendicular to the insertion direction Y, and can broaden the impedance bandwidth of the radiating unit.

In some embodiments, as shown in FIGS. 6-9, each radiating element of the first, second, third, and fourth radiating elements 1, 2, 3, 4 further includes a second bending arm 12. Each second bending arm 12 is bent along the insertion direction Y from another corner portion of the corresponding circumferential arm 101 opposite to a peripheral corner portion of the corresponding radiating element 101 connected to the coupling sheet. The impedance matching can be adjusted through increasing or decreasing the bending size of the second bending arm 12 along the insertion direction Y. The use of the second bending arm 12 can also reduce the lateral dimension of the dual-polarized radiating unit along the direction perpendicular to the insertion direction Y, and broaden the impedance bandwidth of the radiating unit.

In some embodiments, as shown in FIG. 6, the first radiating element 1 further includes a first intersecting part 14. The first coupling sheet 11 is connected to a corresponding peripheral corner portion of the circumferential arm 101 via the first intersecting part 14. The first intersecting part 14 may be recessed downwardly in the insertion direction Y with respect to the circumferential arm 101.

In some embodiments, as shown in FIG. 7, the second radiating element 2 further includes a second intersecting part 24. The second coupling sheet 21 is connected to a peripheral corner portion of the corresponding circumferential arm 101 via the second intersecting part 24. The second intersecting part 24 may project upwardly relative to the circumferential arm 101 in a direction opposite to the insertion direction Y.

In combination with FIGS. 1, 5, and 6, in a case that the first radiating element 1 and the second radiating element 2 are connected to the support element 5, the first intersecting portion 14 and the second intersecting portion 24 intersect with each other and are spaced apart from each other in the insertion direction Y, so as to realize isolation between the first dipole and the second dipole. It should be understood that in other embodiments, the isolation between the first dipole and the second dipole may be realized by other arrangements or in other ways, and the embodiments of the present disclosure are not intended to be limited in this regard.

An example assembly process of the dual-polarized radiating unit is described below in conjunction with FIGS. 1 to 9.

The first coupling sheet 11 of the first radiating element 1 is inserted into the slot 531 on the first side of the first support plate 51 of the support element 5 along the insertion direction Y. Subsequently, a corresponding guiding member 543 on the support element 5 is inserted into the guiding hole 1022 on the first radiating element 1 to guide and position the first radiating element 1. Subsequently, a corresponding first snap-fitting member 541 on the support element 5 is inserted into the first mounting hole 1021 on the first radiating element 1 such that the first snap-fitting member 541 is snap-fitted to one side of the connecting arm 102 of the first radiating element 1 and the corresponding first limiting member 542 abuts against the other side of the connecting arm 102. In this way, the mounting of the first radiating element 1 on the support element 5 is completed.

The second radiating element 2 may be mounted to the support element 5 in a similar manner as the first radiating element 1. For example, the second coupling sheet 21 of the second radiating element 2 can be inserted into the slot 531 on the first side of the second support plate 52 of the support element 5 along the insertion direction Y. Subsequently, a corresponding guiding member 543 on the support element 5 is inserted into the guiding hole 1022 on the second radiating element 2 to guide and position the second radiating element 2. Subsequently, a corresponding first snap-fitting member 541 on the support element 5 is inserted into the first mounting hole 1021 on the second radiating element 2, such that the first snap-fitting member 541 is snap-fitted to one side of the connecting arm 102 of the second radiating element 2 and the corresponding first limiting member 542 abuts against the other side of this connecting arm 102. In this way, the mounting of the second radiating element 2 on the support element 5 is completed.

The third coupling sheet 31 of the third radiating element 3 is inserted into the pair of snaps 532 on the second side of the first support plate 51 of the support element 5 along the insertion direction Y. Subsequently, a corresponding guiding member 543 on the support element 5 is inserted into the guiding hole 1022 on the third radiating element 3 to guide and position the third radiating element 3. Subsequently, a corresponding first snap-fitting member 541 on the support element 5 is inserted into the first mounting hole 1021 on the third radiating element 3 such that the first snap-fitting member 541 is snap-fitted to on one side of the connecting arm 102 of the third radiating element 3 and the corresponding first limiting member 542 abuts against the other side of this connecting arm 102. In this way, the mounting of the third radiating element 3 on the support element 5 is completed.

The third coupling sheet 31 of the third radiating element 3 is inserted into the pair of snaps 532 on the second side of the first support plate 51 of the support element 5 along the insertion direction Y. Subsequently, a corresponding guiding member 543 on the support element 5 is inserted into the guiding hole 1022 on the third radiating element 3 to guide and position the third radiating element 3. Subsequently, a corresponding first snap-fitting member 541 on the support element 5 is inserted into the first mounting hole 1021 on the third radiating element 3 such that the first snap-fitting member 541 is snap-fitted to on one side of the connecting arm 102 of the third radiating element 3 and the corresponding first limiting member 542 abuts against the other side of this connecting arm 102. In this way, the mounting of the third radiating element 3 on the support element 5 is completed.

The fourth radiating element 4 may be mounted to the support element 5 in a similar manner as the third radiating element 3. For example, the fourth coupling sheet 41 of the fourth radiating element 4 is inserted into the pair of snaps 532 on the second side of the second support plate 52 of the support element 5 along the insertion direction Y. Subsequently, a corresponding guiding member 543 on the support element 5 is inserted into the guiding hole 1022 on the fourth radiating element 4 to guide and position the fourth radiating element 4. Subsequently, a corresponding first snap-fitting member 541 on the support element 5 is inserted into the first mounting hole 1021 on the fourth radiating element 4 such that the first snap-fitting member 541 is snap-fitted to one side of the connecting arm 102 of the fourth radiating element 4 and the corresponding first limiting member 542 abuts against the other side of this connecting arm 102. In this way, the mounting of the fourth radiating element 4 on the support element 5 is completed.

In assembling the dual-polarized radiating unit, it is only necessary to initially position the first, second, third, and fourth radiating elements 1, 2, 3, 4 with respect to the support element 5 and to subsequently press and embed the individual radiating elements onto the support element 5, so that no soldered joints need to be used in the assembling process, which can significantly reduce the risk of intermodulation distortion.

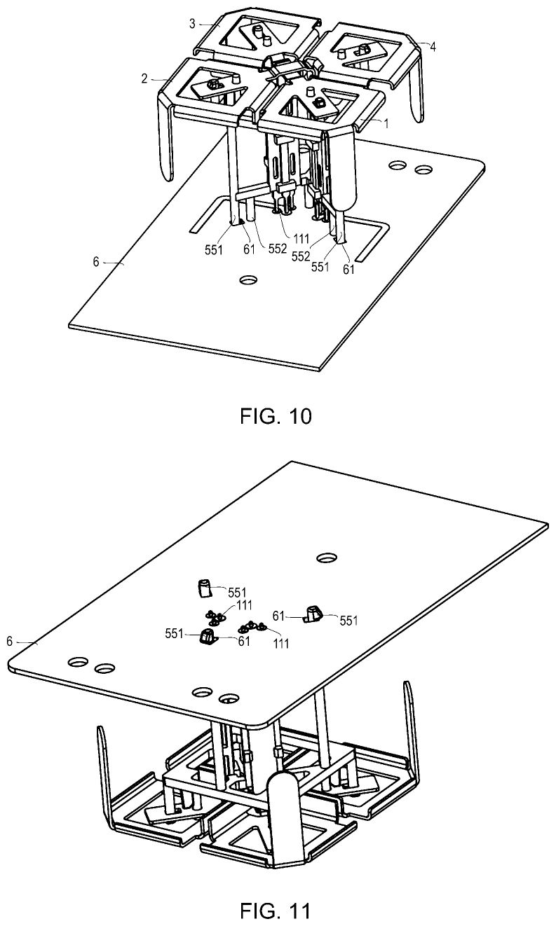

Upon completion of assembling of the dual-polarized radiating unit, the dual-polarized radiating unit may be secured to the feeding circuit board. FIGS. 10 and 11 illustrate schematic assembling views of the dual-polarized radiating unit on a feeding circuit board according to an embodiment of the present disclosure.

In conjunction with FIGS. 5, 10, and 11, the support element 5 further includes a second snap-fitting member 551 and a second limiting member 552 arranged in a group, the second snap-fitting member 551 and the second limiting members 552 are disposed at an end of the support element 5 away from the first snap-fitting member 541 and the first limiting member 542. Each second snap-fitting member 551 is capable of being snap-fitted to one side of the feeding circuit board 6 via a second mounting hole 61 on the feeding circuit board 6, as shown in FIG. 11. Each second limiting member 552 is capable of abutting against the other side of the feeding circuit board 6 in a case that the corresponding second snap-fitting member 551 is snap-fitted to one side of the feeding circuit board 6, as shown in FIG. 10.

In conjunction with FIGS. 6-11, the ends 111 of the first, second, third, and fourth coupling sheets 11, 21, 31, 41 may be soldered to the feeding circuit board 6, thereby electrically connecting the first, second, third, and fourth radiating elements 1, 2, 3, 4 to the feeding circuit board 6.

In fixing the dual-polarized radiating unit to the feeding circuit board 6, the individual second snap-fitting members 551 on the support element 5 may first be inserted into the corresponding second mounting holes 61 on the feeding circuit board 6, such that each second snap-fitting member 551 is snap-fitted to one side of the feeding circuit board 6, and each second limiting member 552 abuts against the other side of the feeding circuit board 6. Subsequently, the ends 111 of the first, second, third, and fourth coupling sheets 11, 21, 31, 41 can be soldered to the feeding circuit board 6 through a surface mount technology (SMT) or other soldering processes. For example, the ends 111 of the first coupling sheet 11 and the second coupling sheet 21 may be soldered to the feed network solder pads on the feeding circuit board 6, and the ends 111 of the third coupling sheet 31 and the fourth coupling sheet 41 are soldered to a ground pad. Subsequently, the radio may output power to the antenna element via the feed network.

In some embodiments, each of the first, second, third, and fourth radiating elements 1, 2, 3, 4 is a one-piece sheet-metal stamping member. For example, each radiating element may be made of an aluminum alloy that may be 0.5 mm thick with a tin-plated surface finish. The dipole in the dual-polarized radiating unit can be lightened by 50% or even more compared to a die-cast dipole, which can significantly reduce the weight of the dual-polarized radiating unit. As a result, it can be more easily applied in 5G AAS antennas.

It should be understood that each of the first, second, third, and fourth radiating elements 1, 2, 3, 4 may also be fabricated by other manufacturing processes, and the embodiments of the present disclosure are not intended to be limited in this regard.

In some embodiments, the support element 5 is an injection molded plastic member. Such a support element 5 is easy to be molded and is structurally stable and reliable. It should be understood that the support element 5 may also be made by other manufacturing processes or by utilizing other insulating materials, and the embodiments of the present disclosure do not limit this.

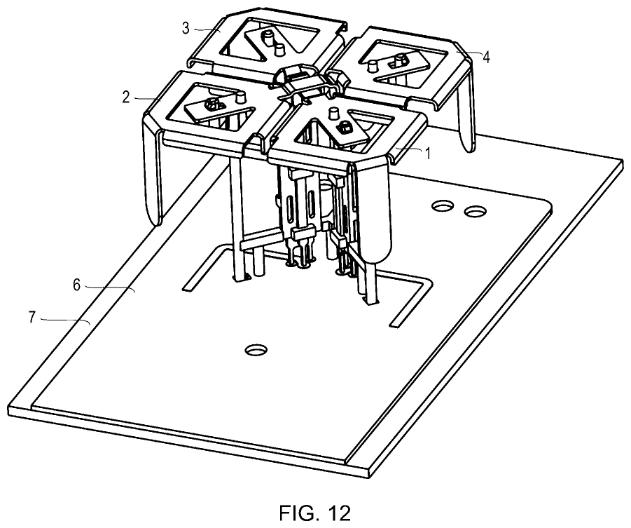

Embodiments of the present disclosure also provide an ultra-wideband antenna, as shown in FIG. 12. The ultra-wideband antenna includes a metal reflection plate 7 for supporting dual-polarized radiating units. the metal reflection plate 7 may be arranged below the feeding circuit board 6. The metal reflection plate 7 may be provided with at least two dual-polarized radiating units as described above to form an array of radiating units. Only one dual-polarized radiating unit is shown in FIG. 12 as an example.

Various embodiments of the present disclosure have been described above, which are example, not exhaustive, and are not limited to embodiments of the present disclosures. Without deviating from the scope and spirit of the various embodiments explained, many modifications and changes are apparent for those skilled in the art. The selection of terms used herein is intended to best explain the principles, practical applications, or technological improvements in the market of each embodiment, or to enable those skilled in the art to understand embodiments of the present disclosures.

1. A dual-polarized radiating unit characterized by-comprising:
a support element;
a first radiating element comprising a first coupling sheet capable of being inserted into the support element along an insertion direction;
a second radiating element comprising a second coupling sheet capable of being inserted into the support element along the insertion direction;
a third radiating element forming a first dipole with the first radiating element, the third radiating element comprising a third coupling sheet capable of being inserted into the support element along the insertion direction, the third coupling sheet being adjacent to the first coupling sheet and extending in parallel with the first coupling sheet; and
a fourth radiating element forming a second dipole with the second radiating element, the fourth radiating element comprising a fourth coupling sheet capable of being inserted into the support element along the insertion direction, the fourth coupling sheet being adjacent to the second coupling sheet and extending in parallel with the second coupling sheet.

2. The dual-polarized radiating unit of claim 1, wherein the support element comprises first and second support plates extending along the insertion direction respectively, and each of the first and second support plates comprises first and second sides opposite to each other;
the first coupling sheet is capable of being inserted into the support element along the first side of the first support plate;
the second coupling sheet is capable of being inserted into the support element along the first side of the second support plate;
the third coupling sheet is capable of being inserted into the support element along the second side of the first support plate; and
the fourth coupling sheet is capable of being inserted into the support element along the second side of the second support plate.

3. The dual-polarized radiating unit of claim 2, wherein the first and second sides of each of the first and second support plates are provided with a slot or a pair of snaps, respectively, for a corresponding coupling sheet to be inserted therein.

4. The dual-polarized radiating unit of claim 1, wherein each of the first, second, third, and fourth radiating elements further comprises a main radiating arm extending along a direction perpendicular to the insertion direction, each main radiating arm comprises a circumferential arm encircling a predefined shape and a connecting arm extending inside the circumferential arm, the first, second, third, and fourth coupling sheets are connected to a peripheral corner portion of the corresponding circumferential arm respectively, and each connecting arm is capable of being connected to the support element.

5. The dual-polarized radiating unit of claim 4, wherein each connecting arm comprises a first mounting hole, and the support element comprises a first snap-fitting member and a first limiting member arranged in a group, each first snap-fitting member is capable of being snap-fitted to a side of the corresponding connecting arm via the corresponding first mounting hole, and each first limiting member is capable of abutting against the other side of the corresponding connecting arm in a case that the corresponding first snap-fitting member is snap-fitted to the side of the corresponding connecting arm.

6. The dual-polarized radiating unit of claim 5, wherein each connecting arm further comprises a guiding hole, and the support element further comprises a guiding member arranged in a group with the first snap-fitting member and the first limiting member, each guiding member is capable of being inserted into the corresponding guiding hole.

7. The dual-polarized radiating unit of claim 4, wherein each of the first, second, third, and fourth radiating elements further comprises at least one of:
a first bending arm bent along the insertion direction from a side of the circumferential arm; and
a second bending arm bent along the insertion direction from another corner portion of the circumferential arm opposite to the peripheral corner portion.

8. The dual-polarized radiating unit of claim 4, wherein the first radiating element further comprises a first intersecting part, wherein the first coupling sheet is connected the peripheral corner portion of the corresponding circumferential arm via the first intersecting part;
the second radiating element further comprising a second intersecting part, wherein the second coupling sheet is connected to the peripheral corner portion of the corresponding circumferential arm via the second intersecting part; and
the first intersecting part and the second intersecting part intersect with each other and are spaced apart from each other along the insertion direction.

9. The dual-polarized radiating unit of claim 1, wherein the support element further comprises a second snap-fitting member and a second limiting member arranged in a group, each second snap-fitting member is capable of being snap-fitted to a side of a feeding circuit board via a second mounting hole, on the feeding circuit board, and each second limiting member is capable of abutting against the other side of the feeding circuit board in a case that the corresponding second snap-fitting member is snap-fitted to the side of the feeding circuit board; and
ends of the first, second, third, and fourth coupling sheets are capable of being soldered to the feeding circuit board.

10. The dual-polarized radiating unit of claim 1, wherein each of the first, second, third, and fourth radiating elements is a sheet-metal stamping member formed integrally.

11. The dual-polarized radiating unit of claim 1, wherein the support element is an injection-molded plastic member.

12. An ultra-wideband antenna comprising:
a metal reflection plate;
a support element;
a first radiating element comprising a first coupling sheet capable of being inserted into the support element alone an insertion direction;
a second radiating element comprising a second coupling sheet capable of being inserted into the support element along the insertion direction;
a third radiating element forming a first dipole with the first radiating element, the third radiating element comprising a third coupling sheet capable of being inserted into the support element along the insertion direction, the third coupling sheet being adjacent to the first coupling sheet and extending in parallel with the first coupling sheet; and
a fourth radiating element forming a second dipole with the second radiating element the fourth radiating element comprising a fourth coupling sheet capable of being inserted into the support element along the insertion direction, the fourth coupling sheet being adjacent to the second coupling sheet and extending in parallel with the second coupling sheet, wherein the first radiating element, the second radiating element, the third radiating element, and the fourth radiating element are arranged on the metal reflection plate.
